(19) United States
(12) Patent Application Publication
(10) Pub. No.: US 2026/0024213 A1
(43) Pub. Date: Jan. 22, 2026

(54) BATTERY AND SYSTEM AND METHOD FOR MANUFACTURING THE SAME

(71) Applicants: Hyundai Motor Company, Seoul (KR); Kia Corporation, Seoul (KR)

(72) Inventors: Jeong Yoon Lee, Hwaseong (KR); Jin Ho Ban, Hwaseong (KR)

(21) Appl. No.: 18/946,004

(22) Filed: Nov. 13, 2024

(30) Foreign Application Priority Data
Jul. 22, 2024 (KR) 10-2024-0096166

(51) Int. Cl. G06T 7/13; G06T 7/00; H01M 10/04

(52) U.S. Cl. CPC G06T 7/13; G06T 7/0004; H01M 10/0404; H01M 10/0459

(57) ABSTRACT

A method for manufacturing an electrode of a battery includes manufacturing a cell stack, wherein an anode, a separator, a cathode, and a separator are repeatedly stacked in a stack direction in a predetermined number of layers, and determining, by a camera, whether the separator stacked in the cell stack is damaged. An electrode and a secondary battery including the electrode are described as well.

### CROSS-REFERENCE TO RELATED APPLICATION

This application claims, under 35 U.S.C. § 119 (a), the benefit of Korean Patent Application No. 10-2024-0096166, filed on Jul. 22, 2024, the entire contents of which are incorporated herein by reference.

### BACKGROUND

### Technical Field

The present disclosure relates to a secondary battery, and more particularly, to a system and method for manufacturing electrodes used in secondary batteries.

### Background

A secondary battery, unlike a primary battery, is an energy source rechargeable and reusable. Due to the environmental friendliness of the secondary battery, the application thereof is expanding in various industrial fields, such as an electric vehicle, an electronic device, and an energy storage system, and research and development on the secondary battery is being actively conducted.

The secondary battery includes a cell stack in which an anode, separator, and cathode are stacked. A method for manufacturing the cell stack includes a method in which an anode and a cathode are placed on a separator and rolled up to make a jelly roll, and a method in which an anode, cathode, and separator are stacked.

The latter method may be a so-called Z-stacking manner in which an anode and a cathode are alternately stacked on the separator. In the Z-stacking manner, anodes and cathodes cut to have a predetermined size are prepared, and an anode and a cathode are alternately inserted between each layer of the separator folded to have a Z-shaped cross section. In this cell stack, when the separator is damaged during the stacking process, the cathode and anode may face each other, decreasing in quality.

The above information disclosed in this Background section is only for enhancement of understanding of the background of the present disclosure, and therefore it may contain information that does not form the prior art that is already known to one having ordinary skill in the art.

### SUMMARY OF THE DISCLOSURE

The present disclosure has been made in an effort to solve the above-described problems associated with the existing technologies, and an object of the present disclosure is to provide a battery capable of preventing damage of a separator arranged within the battery.

Another object of the present disclosure is to provide a system and method for manufacturing an electrode of the battery.

Another object of the present disclosure is to provide a system and method for manufacturing an electrode of a battery, capable of preventing damage of a separator during the manufacture of the electrode.

Another object of the present disclosure is to provide a battery capable of improving the quality of an electrode, and a method and system for manufacturing the same.

The object of the present disclosure is not limited to the foregoing, and other objects not mentioned herein will be clearly understood by one having ordinary skill in the art to which the present disclosure pertains based on the description below.

The features of the present disclosure to achieve the object of the present disclosure as described above and to perform the characteristic functions of the present disclosure to be described later are as follows.

According to some forms of the present disclosure, a method for manufacturing an electrode of a battery includes manufacturing a cell stack, wherein an anode, a separator, a cathode, and a separator are repeatedly stacked in a stack direction in a predetermined number of layers, and determining, by a camera, whether the separator stacked in the cell stack is damaged.

A method for manufacturing a cell stack for a battery may include determining whether a separator is damaged based on the number of edges detected by a camera. The method may involve forming an extended portion in each layer of the separator using a separator processing portion and stacking each layer of the separator with the extended portion in the cell stack, where the edges of each extended portion are offset by a predetermined interval.

To determine if the separator in the cell stack is damaged, the method may involve detecting the number of edges at a first side and a second side of the stacked extended portion. These sides may face each other with respect to the stack direction. The method may further include determining that the separator is undamaged if the number of edges at the first side equals the predetermined number of layers, and the number of edges at the second side is one.

The extended portions may be stacked during a first cycle comprising a predetermined number of layers, and the method may repeat a second cycle identical to the first after completing the first cycle. Additionally, the method may include forming a first extended portion, a second extended portion, and a third extended portion in each separator, then sequentially stacking a first separator with the first extended portion, a second separator with the second extended portion, and a third separator with the third extended portion. The second extended portion may be offset toward a first side relative to the first extended portion, and the third extended portion may be offset toward the first side relative to the second extended portion.

The method may also use a machine vision camera to detect the edges of the extended portions. The separator may be continuously supplied and folded so that the anode and cathode are alternately placed between each layer of the separator. During manufacturing, the method may include forming a plurality of extended portions in the separator with cutouts spaced at predetermined intervals and folding the separator so that the positions of the extended portions are offset.

The method may determine if the separator is damaged by detecting the number of edges at a first side and a second side of the stacked extended portion, ensuring that the number of edges at the first side equals the predetermined number of layers and the number of edges at the second side is one. The cell stack may be manufactured using various methods, such as winding, stacking, Z-stacking, or stack-and-fold techniques.

Multiple cameras may be used, positioned in the stack direction, to detect the edges of the extended portions from various perspectives. The method may involve a first camera inspecting and counting the edges at a first inspection region on one side of the extended portion, while a second camera inspects and counts the edges at a second inspection region on the opposite side.

According to some forms of the present disclosure, as a battery including a cell stack in which an anode, a separator, a cathode, and a separator are repeatedly stacked in a stack direction in a predetermined number of layers, the battery includes the cathode including an cathode tab protruding from the cathode in a first direction perpendicular to the stack direction, wherein the cathode tab extends by a first length in a second direction that lies in a same plane as the first direction, and includes the separator including an extended portion protruding from the separator, wherein the extended portion is arranged to be adjacent to the cathode tab and an extended length of the extended portion in the second direction is greater than the first length.

The anode may include an anode tab protruding from the anode, and the anode tab may be arranged such that it is not adjacent to the cathode tab.

The battery may be a secondary battery.

According to some forms of the present disclosure, a system for manufacturing an electrode of a battery includes a stack table rotatable about an axis, a gripper configured to grip a separator continuously supplied to the stack table and be movable with respect to the stack table, wherein the gripper is configured to assist folding of the separator being folded by a rotation of the stack table, a transfer machine configured to alternately place an anode and a cathode in a stack direction between each layer of the separator being folded, and a separator processing portion configured to form a plurality of extended portions in the separator being supplied to the stack table.

The system may include a camera configured to detect the number of edges of the extended portions stacked on the stack table. The separator processing portion may form the plurality of extended portions such that the extended portions are offset from each other at predetermined intervals when stacked in the stack direction. Additionally, the separator processing portion may perform one cycle so that a predetermined number of extended portions is stacked in an offset manner relative to each other, with the cycle repeated in such a way that the extended portions stacked in each cycle are arranged in an identical manner.

Other aspects and preferred embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

As discussed, the method and system suitably include use of a controller or processor.

The above and other features of the present disclosure are discussed infra.

### BRIEF DESCRIPTION OF THE DRAWINGS

The above and other features of the present disclosure will now be described in detail with reference to certain embodiments thereof illustrated in the accompanying drawings which are given herein below by way of illustration only, and thus are not limitative of the present disclosure, and wherein:

FIG. 1 is a diagram of an electrode manufacturing system according to the present disclosure;

FIG. 2 illustrates a process of manufacturing a cell stack in an electrode manufacturing system;

FIG. 3 illustrates a cell stack manufactured by an electrode manufacturing system according to the present disclosure;

FIG. 4A illustrates a cell stack according to an embodiment of the present disclosure viewed from a cathode side;

FIG. 4B illustrates a cell stack according to an embodiment of the present disclosure viewed from an anode side;

FIG. 5A is a cell stack of the prior art viewed from a cathode side;

FIG. 5B is a cell stack of the prior art viewed from an anode side;

FIG. 5C is a cell stack of the prior art having a damaged separator, viewed from an anode side;

FIG. 6A is a cell stack according to an embodiment of the present disclosure having a damaged separator, viewed from an anode side;

FIG. 6B is a cell stack according to an embodiment of the present disclosure having a damaged separator, viewed from a cathode side;

FIG. 7 illustrates a separator processed by an electrode manufacturing system according to an embodiment of the present disclosure;

FIGS. 8, 9, and 10 illustrate the number of edges of an extended portion detected by a camera while a separator is sequentially stacked;

FIG. 11A schematically illustrates one side of an exemplary cell stack manufactured by an electrode manufacturing system according to an embodiment of the present disclosure;

FIG. 11B illustrates region R1 in FIG. 11A, detected by a first camera;

FIG. 11C illustrates region R2 in FIG. 11A, detected by a second camera;

FIG. 12 illustrates edges of an extended portion detected in region R1 and region R2, respectively, during cycle C1 in FIG. 11A;

FIG. 13A schematically illustrates one side of an exemplary cell stack manufactured by an electrode manufacturing system according to an embodiment of the present disclosure;

FIG. 13B illustrates region R1 in FIG. 13A, detected by a first camera;

FIG. 13C illustrates region R2 in FIG. 13A, detected by a second camera; and

FIG. 14 illustrates edges of an extended portion detected in region R1 and region R2, respectively, during cycle C2 in FIG. 13A.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between”, “adjacent” versus “directly adjacent”, etc.).

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMS, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present disclosure is described in detail with reference to the accompanying drawings.

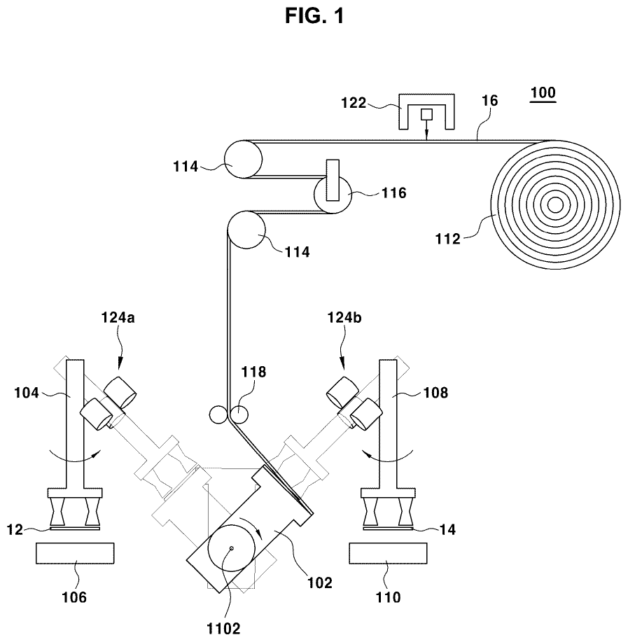

As illustrated in FIG. 1, an electrode manufacturing system 100 according to the present disclosure is configured to manufacture a cell stack 10 of a battery. The cell stack 10 includes one or more cathodes 12, one or more anodes 14, and one or more separators 16. The battery may be a secondary battery, e.g., a lithium-ion battery.

The electrode manufacturing system 100 may manufacture the cell stack 10 by alternately stacking the cathode 12, the separator 16, the anode 14, and the separator 16 in a predetermined number. In one implementation, the electrode manufacturing system 100 may manufacture the cell stack 10 in a Z-stacking manner. In the Z-stacking manner, the cell stack 10 may be manufactured by alternately stacking the cathode 12 and the anode 14 between each layer of the separator 16 folded to have a Z-shaped cross section. In another implementation, the electrode manufacturing system 100 may manufacture the cell stack 10 in a stacking manner. In the stacking manner, the cathode 12 and the anode 14 are alternately stacked between separators prepared to have a predetermined size to manufacture the cell stack 10. In a further different implementation, the electrode manufacturing system 100 may manufacture the cell stack 10 in a winding manner. In the winding manner, the separator 16 is placed between the cathode 12 and the anode 14 and then is rolled up. In a further different implementation, the electrode manufacturing system 100 may manufacture the cell stack 10 in a stack-and-fold manner. In the stack-and-fold manner, a bi-cell is placed on the separator 16 and then is rolled up to manufacture the cell stack 10.

Taking the Z-stacking manner as an example, the electrode manufacturing system 100 includes a stack table 102 configured to be rotatable about an axis 1102. On the stack table 102, stacking of the cathode 12, the anode 14, and the separator 16 is performed.

The separator 16 is continuously supplied to the stack table 102. The cathode 12 and the anode 14 cut to have a predetermined size are alternately supplied onto the separator supplied to the stack table 102. The cathode 12 in the predetermined size is stacked on a cathode supply portion 106 and the anode 14 in the predetermined size is stacked on an anode supply portion 110. The cathode 12 may be supplied from the cathode supply portion 106 to the stack table 102 using a first transfer machine 104, and the anode 14 may be supplied from the anode supply portion 110 to the stack table 102 using a second transfer machine 108. In one example, the first transfer machine 104 may pick up the cathode 12 from the cathode supply portion 106 through vacuum suction to deliver the cathode 12 to the stack table 102, and the second transfer machine 108 may pick up the anode 14 from the anode supply portion 110 through vacuum suction to deliver the anode 14 to the stack table 102.

The separator 16 is unwound from a separator unwinder 112 and is supplied to the stack table 102. So as to move the separator 16 to the stack table 102, one or more rollers 114 to guide the separator 16 along a movement direction D1, one or more dancer rolls 116 to control the tension of the separator 16, one or more nip rolls 118, etc., may be placed on the movement path of the separator 16.

The stack table 102 and the transfer machines 104 and 108 are rotatable. When the cathode 12 is arranged on the separator 16 placed on the stack table 102, the first transfer machine 104 and the stack table 102 may rotate toward each other. When the anode 14 is arranged on the separator 16, the second transfer machine 108 and the stack table 102 may rotate toward each other. Moreover, a gripper 120 movable with respect to the stack table 102 may assist the manufacture of the cell stack 10, such as stacking of the cathode 12 and the anode 14.

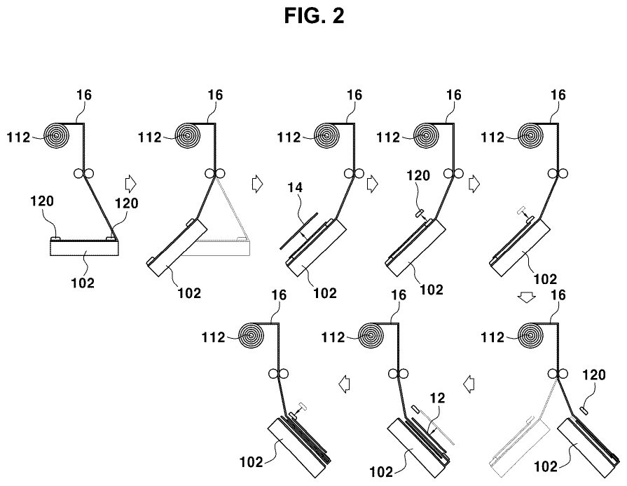

Referring to FIG. 2, the cooperative operation of the stack table 102 and the transfer machines 104 and 108 for manufacturing the cell stack 10 is as follows. The separator 16 unwound from the separator unwinder 112 is fixed on the stack table 102 by the gripper 120. So as to put the anode 14 on the separator 16 placed on the stack table 102, the stack table 102 may rotate toward the anode supply portion 110. The separator unwinder 112 may be properly driven to adjust the length, tension, etc., of the separator 16. The anode 14 is supplied to the stack table 102 using the second transfer machine 108. After the anode 14 is stacked, the gripper 120 moves above the anode 14 while moving forward or rearward. Thereafter, for stacking of the cathode 12, the stack table 102 rotates toward the cathode supply portion 106, and the separator unwinder 112 is driven to stack the separator 16 on the stacked anode 14. Next, the cathode 12 is supplied to the stack table 102 by the first transfer machine 104. By repeating said process, the cell stack 10 may be manufactured. Here, it is explained that the first transfer machine 104 is used for the cathode 12 and the second transfer machine 108 is used for the anode 14, but such relations are simply for the clarity of explanation.

Referring again to FIG. 1, the electrode manufacturing system 100 according to the present disclosure includes a separator processing portion 122. The separator processing portion 122 is configured to process the separator 16, which is to be stacked, to have a predetermined shape. For example, the separator processing portion 122 may process or cut the separator 16 into a predetermined shape using a laser.

As is described below, the separator processing portion 122 is configured to form one or more extended portions 18 on the separator 16. The extended portion 18 may be created by the separator processing portion 122 that cuts out portions of the separator 16 at a predetermined interval. The cutout cut from the separator 16 may be adjusted to have a predetermined size. By the adjustment, the extended portion 18 in one cycle C1 and the extended portion 18 in one cycle C2 may be offset laterally from each other when the separator 16 is stacked in the cell stack 10. Accordingly, by counting the edges of the stacked extended portions 18, whether the separator 16 stacked in the cell stack 10 is damaged may be determined by each layer of the separator 16.

The electrode manufacturing system 100 further includes cameras 124a and 124b. The cameras 124a and 124b may obtain images of the separator 16 being manufactured in the cell stack 10 placed on the stack table 102. The images obtained by the cameras 124a and 124b may be used as a basis for determining whether the separator 16 is damaged. For example, the cameras 124a and 124b are configured to count the number of edges of the extended portion 18 stacked in the cell stack 10. In one implementation, the cameras 124a and 124b may be machine vision cameras. For example, regions to be inspected by the cameras 124a and 124b may be set by setting a region of interest (ROI) in the cell stack 10 being manufactured. In one implementation, the cameras 124a and 124b may be mounted on at least one of the first transfer machine 104 and second transfer machine 108. Preferably, a first camera 124a may be mounted on the first transfer machine 104, and a second camera 124b may be mounted on the second transferor machine 108. For example, the first camera 124a may count the number of edges on one side of the extended portion 18 by taking the edge on the one side of the extended portion 18 as an inspection region R1, and the second camera 124b may count the number of edges on another side of the extended portion 18 by taking the edge on the other side of the extended portion 18 as an inspection region R2.

The electrode manufacturing system 100 further includes a controller. The controller may communicate with each component of the electrode manufacturing system 100 and control the operation of each component. For example, the controller may control the driving of the separator unwinder 112, the driving of the stack table 102, the driving of the first transfer machine 104, the driving of the second transfer machine 108, the driving of the gripper 120, the driving of the separator processing portion 122, etc. Moreover, the controller may determine whether the separator 16 is damaged based on the images obtained by the cameras 124a and 124b. The controller may be an integrated controller configured to comprehensively control the components or may include a plurality of separate controllers for each component or some components.

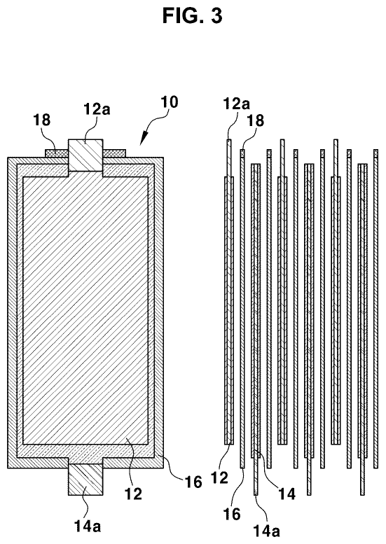

As illustrated in FIG. 3, according to the present disclosure, the separator 16 includes the extended portion 18. In one implementation, the extended portion 18 may be formed by the separator processing portion 122. The separator 16 may, by including the extended portion 18, minimize the possibility of the anode and the cathode facing each other or coming into contact with each other even when the separator shrinks due to an external impact, etc. Moreover, as described above, whether the separator 16 stacked in the cell stack 10 is damaged may be determined by inspecting the extended portion 18.

Generally, the separator of a battery has a rectangular cross-section. However, according to the present disclosure, as shown in the side view on the right of FIG. 3, the separator 16 includes the extended portion 18. The extended portion 18 is provided to be adjacent to a cathode tab 12a. The extended portion 18 may extend in a same direction in which the cathode tab 12a extends from the cathode 12 but only extend at only a portion of a side of the separator 16, at which the extended portion 18 is formed. The separator 16 including the extended portion 18 may improve the insulation characteristic of the cathode tab 12a, thereby improving the safety compared to the existing design. Moreover, according to the present disclosure, even when the separator 16 shrinks due to an external impact applied to the cell stack 10, the possibility of the cathode tab 12a and the anode 14 coming into contact with each other may be minimized owing to the extended portion 18.

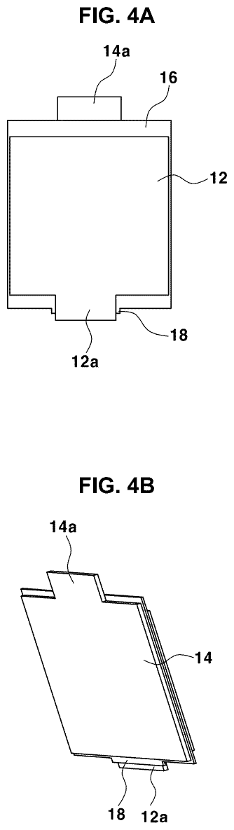

FIGS. 4A and 4B illustrate the cell stack 10 including the separator 16 including the extended portion 18 according to the present disclosure viewed from the cathode 12 side and viewed from the anode 14 side, respectively. In other words, the state of the separator viewed from both the cathode 12 side and the anode 14 side may be observed.

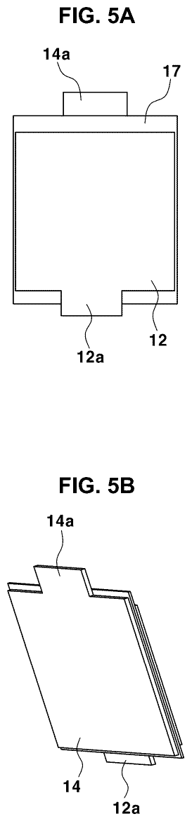

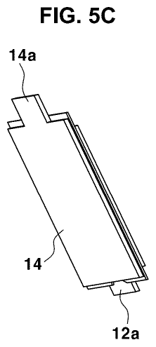

On the other hand, in case of a separator 17 of the prior art as illustrated in FIGS. 5A through 5C, even when the separator 17 is damaged, the damage may not be recognized from a cathode 12 side because the damaged portion is hidden by a cathode tab 12a. In a general battery, the size of a cathode is smaller than the size of an anode in a cell stack. Thus, when a separator has a damage, the damage may be recognized when viewed from the cathode side. However, the damage of the separator cannot be seen when viewed from the cathode side because the damage is hidden by the cathode tab. Accordingly, as illustrated in FIG. 5C, even when the separator 17 has a damage near the cathode tab 12a, the damage may not be recognized when observed from the cathode side, as illustrated in FIG. 5A. Here, the cathode tab 12a and the anode tab 14a are portions protruding outward from the cathode and the anode, respectively, for electrical connection between the cathodes and for electrical connection between the anodes in the cell stack.

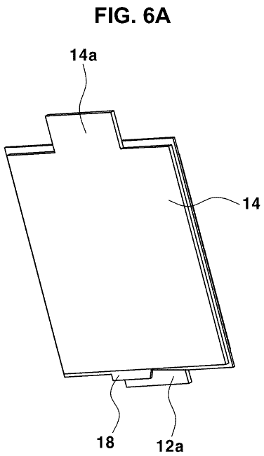

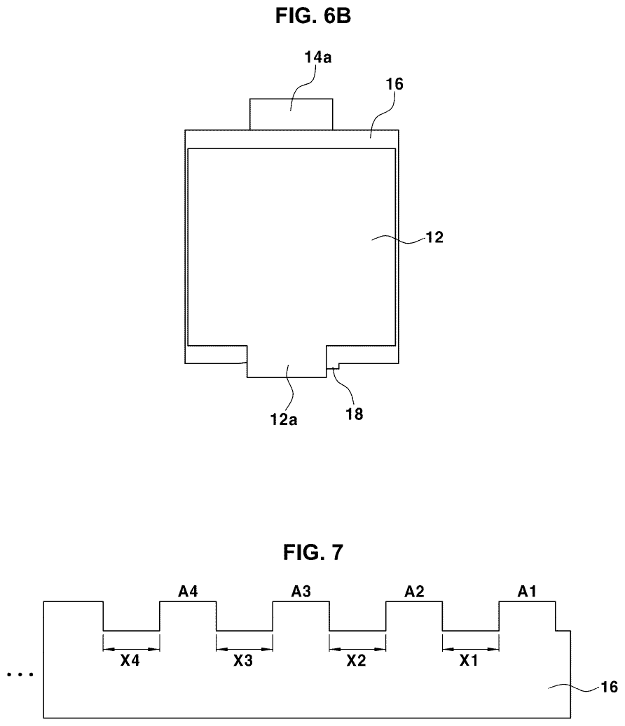

According to the present disclosure, because the separator 16 includes the extended portion 18, when the separator 16 has a damage, the damage may be recognized either from the cathode 12 side or anode 14 side, as illustrated in FIGS. 6A and 6B.

As described above, in the electrode manufacturing system 100 according to the present disclosure, the separator 16 processed by the separator processing portion 122 allows the cameras 124a and 124b to inspect the damage of the separator 16 in the cell stack 10.

As illustrated in FIG. 7, in the Z-stacking manner, the separator 16 is supplied to the stack table 102 by the separator unwinder 112 in the form of a continuous sheet along the movement direction of the separator 16. The separator processing portion 122 arranged downstream of the separator unwinder 112 forms the extended portion 18 in the separator 16.

The separator processing portion 122 makes each extended portion 18 to be equal in length. For example, an extended portion A1 denoted as “A1”, an extended portion A2 denoted as “A2”, an extended portion A3 denoted as “A3”, and an extended portion A4 denoted as “A4” are all to have the same length.

However, in one implementation, in the Z-stacking manner or in the winding manner, the size of cutouts (X1, X2, X3, . . . ) between each extended portion 18 may be adjusted. Accordingly, when the separator 16 is stacked together with the cathode 12 and the anode 14, the edge of the extended portion 18 of each separator 16 may be observed in the stack direction.

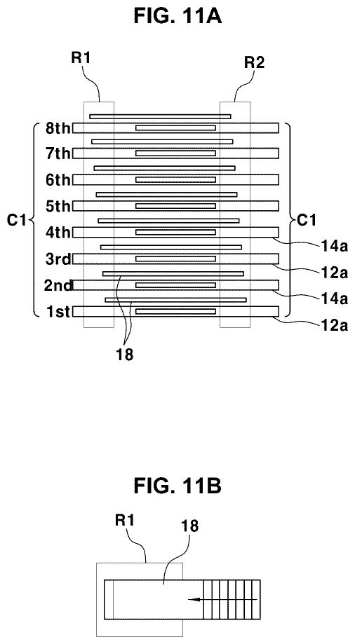

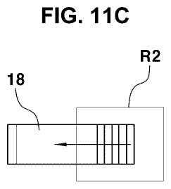

In one implementation, in the stacking manner, the extended portion 18 may be processed so that the position of the extended portion 18 in each cut separator 16 varies. Accordingly, when the separator 16 is stacked together with the cathode 12 and the anode 14, the edge of the extended portion 18 of each separator 16 may be observed in the stack direction (see FIG. 11A).

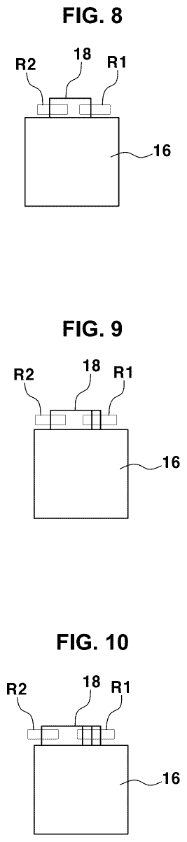

FIG. 8 illustrates a first layer of the separator 16 including the extended portion A1 in the cell stack 10 viewed in the stack direction. Here, a region to be inspected by the first camera 124a is denoted as “R1”, and a region to be inspected by the second camera 124b is denoted as “R2”. In R1 and R2, opposite sides of the extended portion 18 may be inspected, respectively. When one extended portion A1 is stacked, each edge of the opposite sides of the extended portion 18 may be detected by the first camera 124a and the second camera 124b, respectively. In other words, when the separator including the extended portion A1 alone is placed on the stack table 102, the first camera 124a may detect one edge in the region R1, and the second camera 124b may detect another edge in the region R2.

Thereafter, as illustrated in FIG. 9, a second layer of the separator 16 including the extended portion A2 is stacked on the extended portion A1. Here, the first layer of the separator 16 including the extended portion A1 and the second layer of the separator 16 including the extended portion A2 have the same size, yet the positions of the extended portion A2 is changed by adjusting the size of the cutouts (X1, X2, X3, . . . ). When the extended portion A2 is stacked on the extended portion A1 to create the cell stack 10, the first camera 124a may detect the edge of the extended portion A1 and the edge of the extended portion A2, two edges in total, in the region R1. On the other hand, only one edge of the extended portion A2 may be detected in the region R2 because the other edge of the extended portion A1 is hidden by the extended portion A2 formed owing to the cutout (X1).

Similarly, when the extended portion A3 is stacked on the extended portion A2, three edges may be detected in the region R1 and one edge may be detected in the region R2, as illustrated in FIG. 10.

FIG. 11A illustrates an example in which eight different sized cutouts (X1, X2, X3, . . . , X8) are formed between the extended portions 18 by the separator processing portion 122 so that the extended portions 18 are offset from each other in one direction. When processing eight cutouts is considered one cycle C1, a new cycle C2 starts again in the next cycle.

In the cell stack 10, a cathode 12, a separator 16, an anode 14, the separator 16, a cathode 12, . . . are arranged in order. FIG. 11A illustrates a state of the cell stack 10, wherein the cell stack 10 is viewed from the cathode tab 12a side.

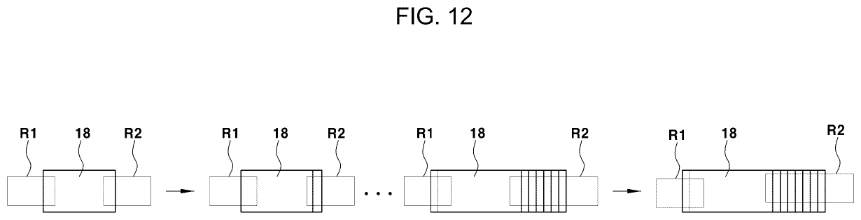

When the separator 16 including the extended portion 18 is stacked, as illustrated in FIG. 11A, the cameras 124a and 124b each may count the number of edges of the extended portions 18. When the separator 16 has no damage, one edge should be detected in R1, and eight edges should be detected in R2 in one cycle C1 in which eight extended portions 18 stacked at different positions are included. In other words, as in FIG. 11B, the number of edges on the side covered by the extended portions 18 that are stacked at increasing intervals or stacked at different positions is detected to be one in the region R1. Conversely, as in FIG. 11C, in the inspection region R2 where the extended portion 18 at the bottom is visible due to the extended portions 18 being stacked, eight edges should be detected. When one edge is detected at one side of the extended portion 18 and eight edges are detected at the other side of the extended portion 18, it may be determined that the separator 16 has no damage in the corresponding cycle C1. FIG. 12 schematically illustrates the staking process of the extended portions 18 of the separator from the bottom to the top in the cycle C1.

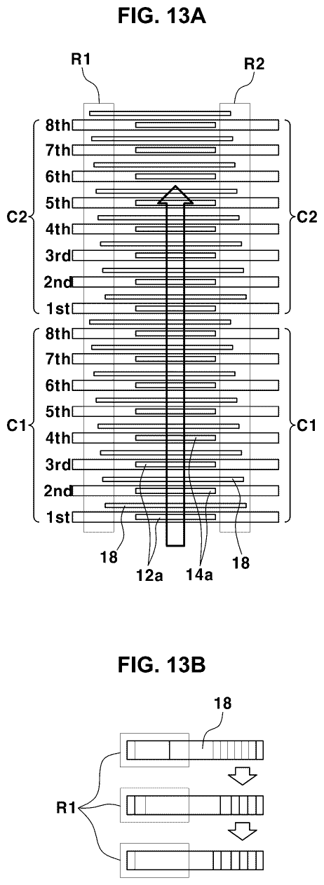

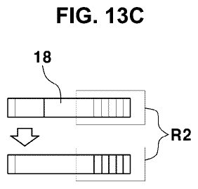

Referring to FIG. 13A, when the cycle C1 is completed, the next cycle, cycle C2, is repeated in the same manner.

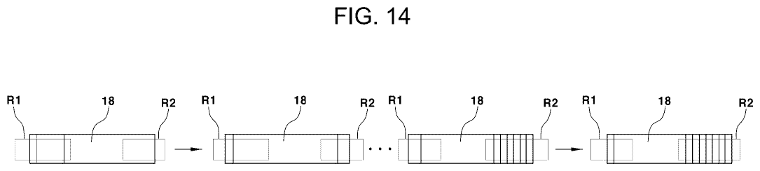

During the cycle C1, eight edges are detected at one of the opposite sides of the extended portion 18. The size of the cutouts (X1, X2, X3, . . . ) between each of the extended portions 18 may be adjusted so that each of the extended portions 18 stacked by the separator processing portion 122 may be offset from each other in one direction. As a new cycle (i.e., cycle C2) begins, the first camera 124a detects the edge of one extended portion 18 and the second camera 124b detects the edges of eight extended portions 18 until the cycle C2 is completed, as illustrated in FIGS. 13B, 13C, and 14, to determine that the separator 16 is not damaged. Here, when the extended portions 18 are stacked up to the cutout X7, two edges (i.e., the edge of the extended portion 18 stacked on the top in the cycle C1 and the edge of the extended portion 18 stacked on the top in the cycle C2) should be detected in the inspection region R1. When the extended portions 18 are stacked up to the cutout X8, one edge is detected in the inspection region R1. In FIG. 13B, the thin line indicates an edge that is not visible when viewed from above, and the thick line indicates an edge that is visible when viewed from above. When the number of edges detected by the second camera 124b does not increase in sequence, such as one, two, three, four, . . . , it is determined that the separator 16 is damaged and response measures may be performed.

According to the present disclosure, provided is an electrode manufacturing system, enabling inspection of damage to a separator during the manufacture of a cell stack.

According to the present disclosure, the quality of a battery may be secured by reducing the possibility of an anode and cathode facing each other through inspection of damage of a separator.

As is apparent from the above description, the present disclosure provides the following effects.

According to the present disclosure, provided is a battery capable of preventing damage of a separator arranged within the battery.

According to the present disclosure, provided are a system and method for manufacturing an electrode of the battery.

According to the present disclosure, provided are a system and method for manufacturing an electrode of a battery, capable of preventing damage of a separator during the manufacture of the electrode.

Lastly, according to the present disclosure, provided are a battery capable of improving the quality of an electrode and a method and system for manufacturing the battery.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A method for manufacturing an electrode of a battery, the method comprising:
manufacturing a cell stack, wherein an anode, a separator, a cathode, and the separator are repeatedly stacked in a stack direction in a predetermined number of layers; and
determining, by a camera system, whether the separator stacked in the cell stack is damaged.

2. The method of claim 1, wherein whether the separator is damaged is determined based on a number of edges of the separator detected by the camera system.

3. The method of claim 1, wherein the manufacturing the cell stack comprises:
forming an extended portion in each layer of the separator by a separator processing portion; and
stacking each layer of the separator having formed therein the extended portion in the cell stack,
wherein the edges of each extended portion are offset by a predetermined interval.

4. The method of claim 3, wherein the determining, by the camera system, whether the separator stacked in the cell stack is damaged comprises:
detecting a number of edges at a first side and a second side of the stacked extended portion, respectively, wherein the first side and the second side face each other with respect to the stack direction; and
determining that the separator has no damage in response to detecting that the number of edges at the first side is equal to a number of the predetermined number of layers, and the number of edges at the second side is equal to one.

5. The method of claim 3, wherein each of the extended portions with edges thereof offset is stacked during a first cycle, in which the extended portions are stacked in a predetermined number of layers, and wherein upon completion of the first cycle, a second cycle, identical to the first cycle, is repeated.

6. The method of claim 1, wherein the manufacturing the cell stack comprises:
forming a first extended portion, a second extended portion, and a third extended portion in each separator by a separator processing portion; and
sequentially stacking a first separator comprising the first extended portion, a second separator comprising the second extended portion, and a third separator comprising the third extended portion, and
wherein, when stacking the first separator, the second separator, and the third separator, the second extended portion is arranged at a position offset toward a first side relative to the first extended portion, and the third extended portion is arranged at a position offset toward the first side relative to the second extended portion.

7. The method of claim 1, wherein the camera system includes a machine vision camera.

8. The method of claim 1, wherein the separator is continuously supplied to be folded so that the anode and the cathode are alternately placed between each layer of the separator.

9. The method of claim 8, wherein the manufacturing the cell stack comprises:
forming a plurality of extended portions in the separator by a separator processing portion, wherein cutouts between each extended portions are spaced at predetermined intervals; and
folding the separator to an identical size so that positions of the extended portions are offset.

10. The method of claim 9, wherein the determining whether the separator is damaged comprises:
detecting, by the camera, a number of edges at a first side and a second side of the stacked extended portion, respectively, wherein the first side and the second side face each other with respect to the stack direction; and
determining that the separator has no damage in response to detecting that the number of edges at the first side is equal to a number of the predetermined number of layers, and the number of edges at the second side is one.

11. The method of claim 1, wherein the cell stack is manufactured in a winding manner, in a stacking manner, in a Z-stacking manner, or in a stack-and-fold manner.

12. The method of claim 3, wherein the camera system further comprises multiple cameras, separated from each other but positioned in the stack direction to enable detection of edges of the extended portions from multiple perspectives.

13. The method of claim 12, wherein the camera system comprises a first camera positioned to inspect and count the edges of the extended portion at a first inspection region on one side of the extended portion, and a second camera positioned to inspect and count the edges of the extended portion at a second inspection region on the opposite side of the extended portion.

14. A battery comprising:
a cell stack in which an anode, a separator, a cathode, and a separator are repeatedly stacked in a stack direction in a predetermined number of layers,
wherein the cathode comprises a cathode tab protruding from the cathode in a first direction perpendicular to the stack direction, the cathode tab extending by a first length in a second direction lying in a same plane as the first direction,
wherein the separator comprises an extended portion protruding from the separator, the extended portion being positioned adjacent to the cathode tab; and
wherein an extended length of the extended portion in the second direction is greater than the first length.

15. The battery of claim 14, wherein the anode comprises an anode tab protruding from the anode, and wherein the anode tab is arranged such that it is not adjacent to the cathode tab.

16. The battery of claim 14, wherein the battery is a secondary battery.

17. A system for manufacturing an electrode of a battery, the system comprising:
a stack table configured to rotate about an axis;
a gripper configured to grip a separator that is continuously supplied to the stack table, the gripper being movable with respect to the stack table, and further configured to assist folding of the separator as it is being folded by a rotation of the stack table;
a transfer machine configured to alternately position an anode and a cathode in a stack direction between each layer of the separator as the separator is being folded; and
a separator processing portion configured to form a plurality of extended portions in the separator as it is being supplied to the stack table.

18. The system of claim 17, comprising a camera configured to detect a number of edges of the extended portions stacked on the stack table.

19. The system of claim 18, wherein the separator processing portion forms the plurality of extended portions such that the extended portions are offset at predetermined intervals from each other when stacked in the stack direction.

20. The system of claim 19, wherein the separator processing portion performs one cycle so that a predetermined number of extended portions is stacked in an offset manner with respect to each other, and wherein the cycle is repeated such that the extended portions stacked in each cycle are arranged in an identical manner.
